(19) United States
(12) Patent Application Publication
(10) Pub. No.: US 2013/0181419 A1
(43) Pub. Date: Jul. 18, 2013

(54) FOOD PAN CARRIER

(71) Applicants: Martin Benning, Edmond, OK (US); Oliver Breit, Hong Kong (HK); Scott Huff, Shekou (CN); Brian Hutton, Edmond, OK (US); Michael Ksiazek, Burr Ridge, IL (US); Michael Rellinger, Chicago, IL (US); David M. Shannon, Edmond, OK (US); Tommy Tian, Nanshan (CN); Josh Wright, Sai Ying Pun (HK); James Zhang, Shekou (CN)

(72) Inventors: Martin Benning, Edmond, OK (US); Oliver Breit, Hong Kong (HK); Scott Huff, Shekou (CN); Brian Hutton, Edmond, OK (US); Michael Ksiazek, Burr Ridge, IL (US); Michael Rellinger, Chicago, IL (US); David M. Shannon, Edmond, OK (US); Tommy Tian, Nanshan (CN); Josh Wright, Sai Ying Pun (HK); James Zhang, Shekou (CN)

(21) Appl. No.: 13/574,538

(22) PCT Filed: Jan. 21, 2011
(86) PCT No.: PCT/US11/22127

§ 371 Date: Mar. 20, 2013

Related U.S. Application Data
(60) Provisional application No. 61/297,548, filed on Jan. 22, 2010.

(51) Int. Cl. B62B 3/00

(52) U.S. Cl. CPC B62B 3/005
USPC 280/79.2

(57) ABSTRACT

A food pan carrier has a pan carrier body with a wheeled dolly attached thereto. The wheeled dolly is connected with at least one fastener. The wheeled dolly is removably connected to the food pan carrier body so that it may be easily connected and disconnected therefrom.

### CROSS REFERENCE TO RELATED APPLICATION

Priority is claimed from U.S. Provisional Patent Application Ser. No. 61/297,548 filed on Jan. 22, 2010, entitled “Food Pan Carrier” contents of which are incorporated herein by reference.

### BACKGROUND

The use of food pan carriers in the food service industry is well known. Food pan carriers are, for example, used to carry food pans in commercial settings for use in buffet tables. The food pan carriers carry pans with both warm and cold foods, and are generally insulated to keep foods at desired temperatures. To move food pan carriers from place to place, the food pan carriers may be placed on a dolly and shopped to the dolly. This can be a burdensome and time-consuming task. There are food pan carriers with wheels directly attached to a pan carrier body, but often a food pan carrier with a flat surface for stacking purposes is desired. Removal of four directly connected wheels is also a time-consuming process. Pan carrier bodies with no dolly, or wheels, may be carried from place to place. Converting back to a mobile food pan carrier requires attachment of all four wheels to a pan carrier body, or strapping a food pan carrier body to a dolly.

### BRIEF DESCRIPTION OF THE DRAWINGS

FIG. 1 is a perspective view of the disclosed food pan carrier.

FIG. 2 is a right side view of the food pan carrier.

FIG. 3 is a left side view of the food pan carrier.

FIG. 4 is a rear side view of the food pan carrier.

FIG. 5 is a front view of the food pan carrier.

FIG. 6 is a top view of the food pan carrier.

FIG. 7 is a bottom view of the food pan carrier.

FIG. 8 is a perspective view of a pan carrier body stacked upon a food pan carrier.

FIG. 9 is a perspective view looking at the bottom side of a pan carrier body.

FIG. 10 is a perspective view showing the top of the wheeled dolly.

FIG. 11 is a perspective view showing the bottom side of the wheeled dolly.

FIG. 12 is a cross section from line 12-12 of FIG. 6.

FIG. 13 is a bottom view of a pan carrier body.

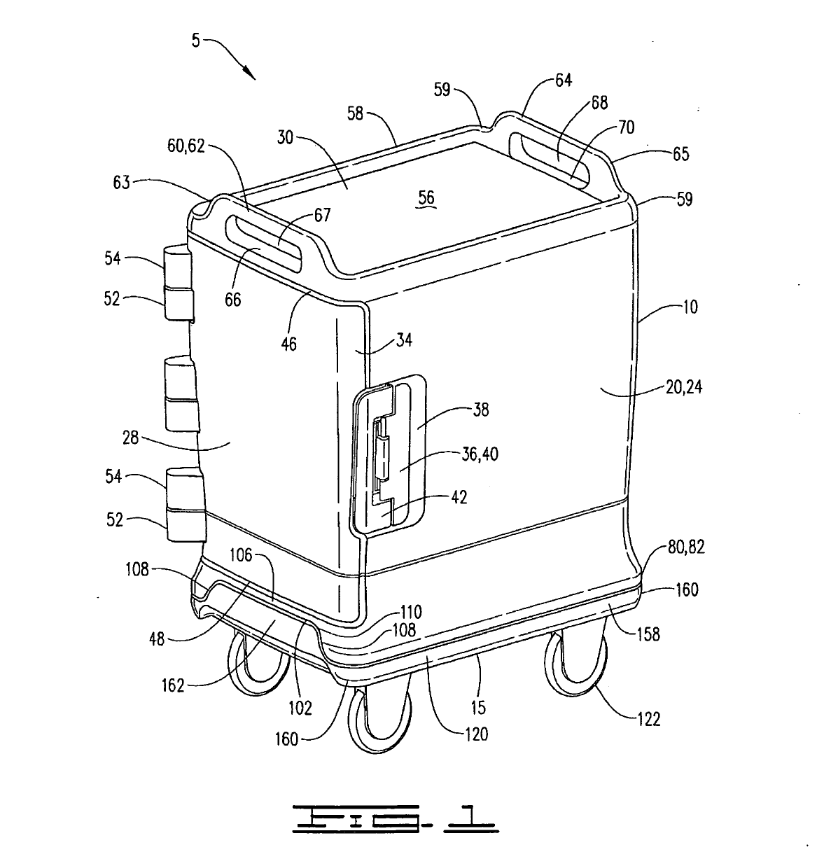

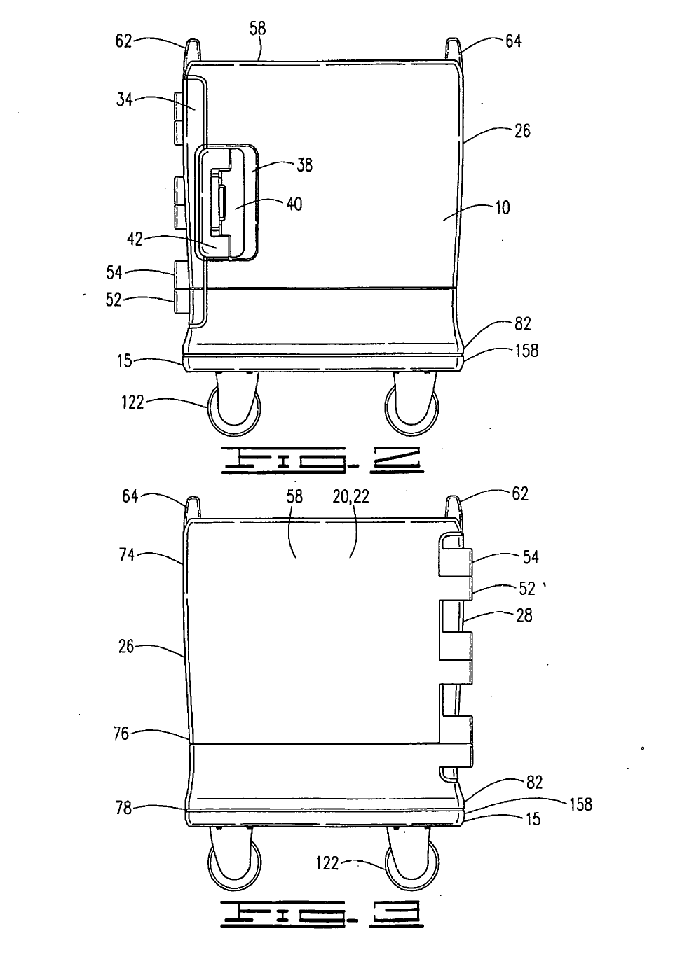

### DESCRIPTION OF AN EMBODIMENT

The current disclosure is directed to a mobile food pan carrier 5. Food pan carrier 5 is a wheeled food pan carrier that is efficiently convertible to a food pan carrier with no wheels referred to as a pan carrier body that can be stacked upon any flat surface, or on top of another food pan carrier. Food pan carrier 5 comprises a pan carrier body 10 and a wheeled dolly 15. Oftentimes, food pan carriers must be stacked at a single location, either for storage or for loading and unloading. In such cases, only the lowermost food pan carrier can have wheels connected thereto. Straps used to hold a food pan carrier to a dolly must be removed prior to stacking. Likewise, food pan carriers with wheels connected directly to a pan carrier body must be disassembled to allow stacking. Wheeled dolly 15 is removably attached to pan carrier body 10 to provide for an easy and quick disconnect of dolly 15 from pan carrier body 10. Disconnection and removal of wheeled dolly 15 will expose flat surfaces on a bottom of pan carrier body 10 to provide for easy stacking of pan carriers like that shown in FIG. 8 in which a pan carrier body 10 is stacked upon a wheeled food pan carrier 5. Pan carrier body 10 transitions smoothly at the engagement between pan carrier body 10 and wheeled dolly 15. As explained in detail herein, pan carrier body 10 has a planar surface that is coplanar with a planar surface on wheeled dolly 15 to create the smooth transition.

Pan carrier body 10 has four sides 20, including first or left side 22, second or right side 24, third or rear side 26 and fourth or forward side 28. Pan carrier body 10 has a top or top side 30 and a bottom or bottom side 32. As is apparent from the drawings, none of the rear, forward, left or right sides are completely flat or planar surfaces but rather each has a curvilinear shape along at least a portion, and preferably a significant portion, of the length thereof. Thus, each of the sides has a curvilinear shape on at least a portion thereof. Pan carrier body 10 defines a body interior 33, which, as is known in the art, will receive and carry food pans having food therein.

A door 34 is hingedly connected at forward side 28 of pan carrier body 10. Door 34 is movable between open and closed positions and may be closed in place with a latch 36 of a type known in the art. Latch 36 may be positioned in a cutout portion 38 of right side 24. Latch 36 may comprise a first latch portion 40 connected to right side 24 and a second latch portion 42 that is hingedly connected to first latch portion 40. Second latch portion 42 will engage door 34 and will latch door 34 in the closed position. At least a portion of latch 36, for example, latch portion 42, may be contoured to match the shape of right side 24, and thus will have a curved surface.

Door 34 has a top edge 46 and a bottom edge 48. Door 34 is hingedly connected to pan carrier body 10 with hinge mounts 52 that are connected to pan carrier body 10 at first side 22 and door hinge mounts 54 connected to door 34. Preferably hinge mounts 52 and 54 are molded with pan carrier body 10 and door 34, respectively. Pins may be molded with and extend upwardly from hinge mounts 52 and be received in openings in door hinge mounts 54.

Top 30 is preferably a flat top and thus comprises a flat surface 56. A top rim 58 extends upwardly above top surface 56 at the left and right sides 22 and 24 of pan carrier body 10. Top rim 58 may extend peripherally around at least a portion of the rear and forward sides 26 and 28, respectively, of pan carrier body 10. Handles 60 comprise forward handle 62 and rear handle 64. Top rim 58 extends around corners 59, and transitions into forward and rear handles 62 and 64. Both of handles 62 and 64 extend upwardly above top rim 58. Handles 62 and 64 have outer peripheral surfaces 63 and 65, respectively, which are preferably identical. An opening 67 is defined by forward handle 62 and a surface 66 that is positioned above top surface 56. An opening 68 is defined by rear handle 64 and a surface 70, which is preferably coplanar with top surface 56. As such, a rim or ledge extends above top surface 56 around the forward side 28 and left and right sides 22 and 24 of pan carrier body 10. In other words, the entire periphery of top surface 56 has a rim thereabout except at the rear thereof where surface 70 is coplanar therewith to provide a drain for liquids that may gather on top surface 56. Thus, liquids that gather on top surface 56 may drain from forward side 28 to rear side 26 through opening 68.

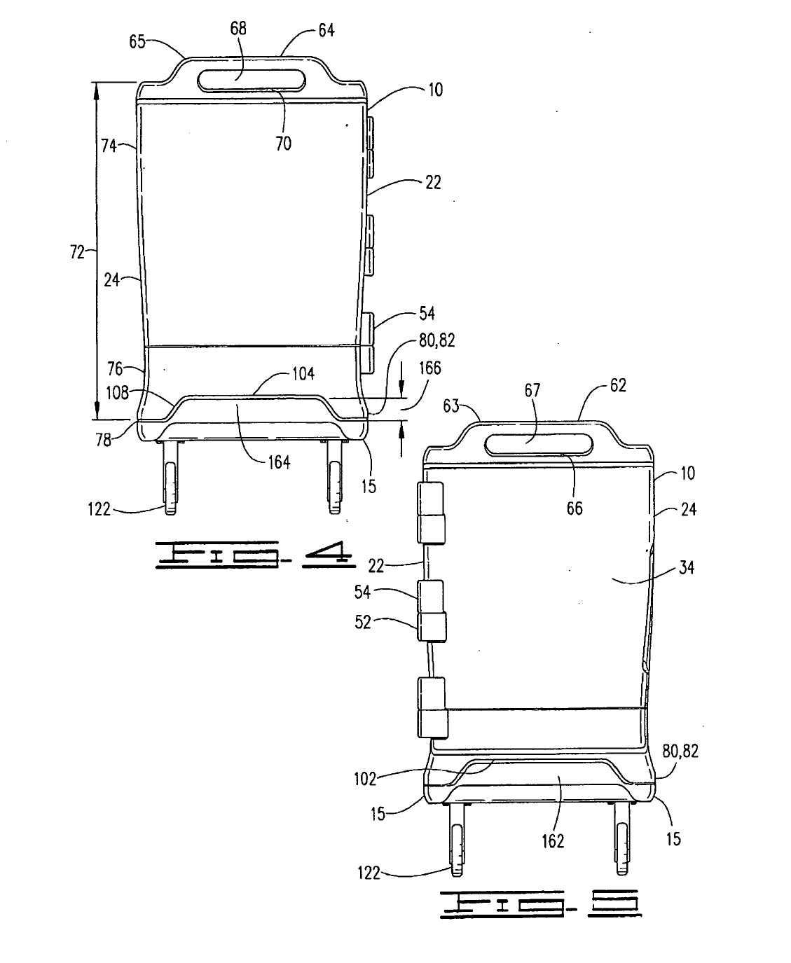

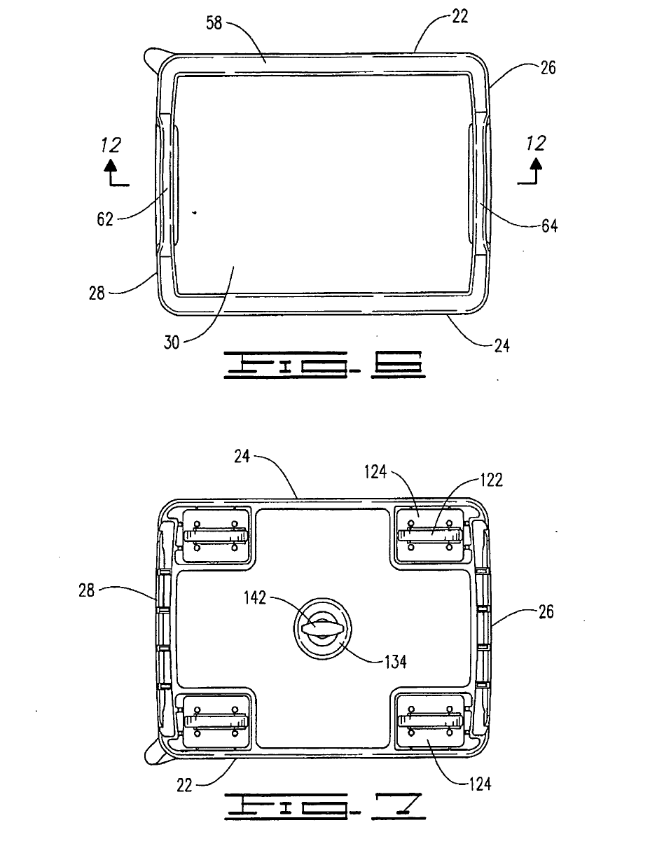

As depicted in the figures pan carrier body 10 has contoured or curved sides. Thus, as shown in FIG. 4 left and right sides 22 and 24, respectively, curve outwardly from a top of rim 58 for a portion of the height 72 of pan carrier body 10. Sides 22 and 24 thus have a slightly convex curvilinear surface 74 that transitions into a concave curvilinear surface 76 near the bottom 32 of pan carrier body 10. A bottom edge 78 which may be referred to as the bottom peripheral edge 78 of pan carrier body 10 is defined by bottom 32. Curvilinear surface 76 curves outwardly until it transitions into a skirt 80 on both of left and right sides 22 and 24. Skirt 80 comprises a straight or planar surface 82 which is generally coplanar with an outer surface of wheeled dolly 15 to create a smooth transition from pan carrier body 10 to wheeled dolly 15.

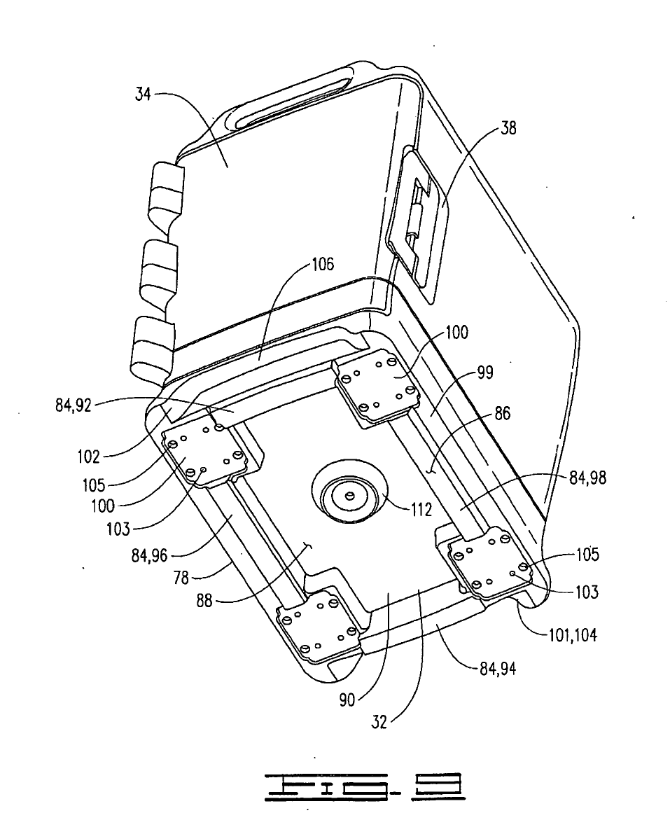

Bottom 32 of pan carrier body 10 comprises a support ring 84 defining a lower or support surface 86. Support ring 84 extends downwardly from a surface 88 of cavity 90 in bottom 32. Support ring 84 includes forward leg or forward portion 92, rear leg or rear portion 94, left side leg or left side portion 96 and right side leg or right side portion 98. Support ring 84 also extends downwardly from an outer peripheral bottom surface 99 which defines peripheral edge 78. At the corners of support ring 84 are generally rectangularly shaped cavities or depressions 100. Cavities 100 are spaced upwardly from surfaces 86 and 99 and are adapted to receive a flat wheel, or caster plate so that, if desired, wheels may be directly attached to pan carrier body 10. Thus, cavities 100 are flat surfaces to which a caster plate or wheel plate may be attached. Cavities or depressions have openings 103 in which fasteners may be received to directly attach wheels thereto. However, the preferred embodiment disclosed herein is a pan carrier 5 comprising pan carrier body 10 with wheeled dolly 15 attached thereto. As shown in FIG. 9, cavities 100 may have additional openings 105 therein. Openings 105 are spaced differently than openings 103 to provide for the attachment of different caster, or wheel plates.

Pan carrier body 10 has cutaway portions 101 which may be referred to as a forward cutaway portion or forward receptacle 102 and a rear cutaway portion or rear receptacle 104. Receptacles 102 and 104 are shaped to receive handles 60 when a pan carrier body 10 is stacked upon another pan carrier body 10. Receptacles 102 and 104 are likewise shaped to receive a portion of wheeled dolly 15 while maintaining a smooth transition from pan carrier body 10 to wheeled dolly 15. Receptacles 102 and 104 both have an upper side 106 and angled sides 108 with a rounded radius or rounded corner transition 110 which transitions smoothly into peripheral bottom surface 99. Both receptacles 102 and 104 have a depth 107.

Bottom 32 has a center post 112 molded therein adapted to engage a mounting post on wheeled dolly 15. Center post 112 may have a threaded member or insert 114 molded therein or otherwise fixed therein adapted to receive a threaded connecting member to attach wheeled dolly 15 to pan carrier body 10.

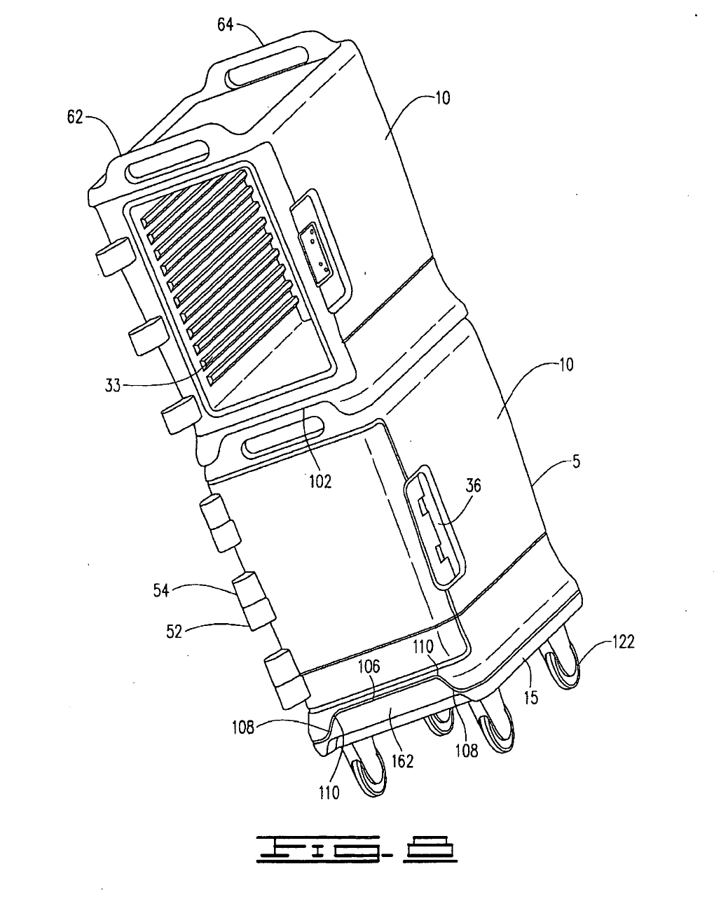

Wheeled dolly 15 comprises a dolly body 120 with a plurality of wheels 122 attached thereto. Wheels 122 may be attached with plates or plate members 124 having fasteners extending therethrough. As shown in FIG. 7, a plurality of protrusions 126 extend upwardly from a floor panel 128 of dolly body 120. Inserts of a type known in the art may be placed in protrusions 126 so that fasteners extending through wheel plates 124 may be threaded therein to hold wheels 122 to dolly body 120. The configuration of bottom 32 will provide clearance for protrusions 126 when wheel dolly 15 is attached to pan carrier body 10. For example, depressions 100 may have a depth such that clearance is provided when dolly 15 is attached to pan carrier body 10.

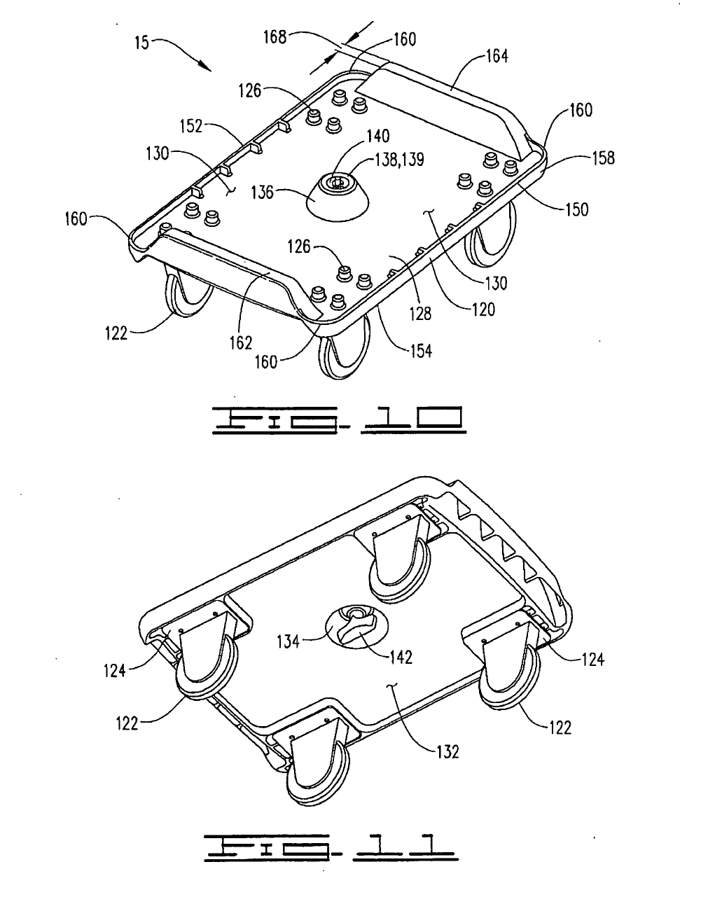

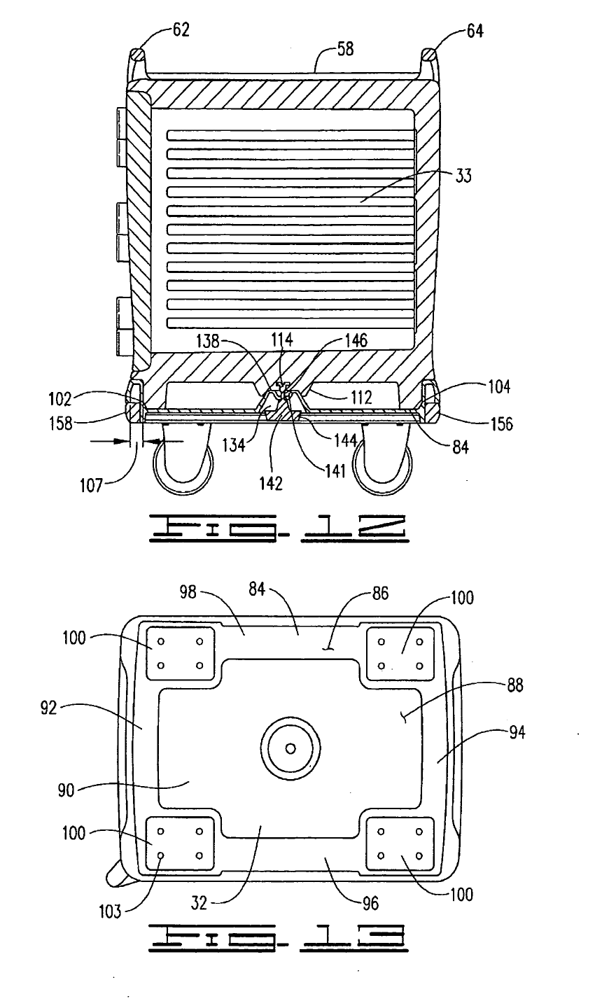

Floor panel 128 has a top surface 130 and a bottom surface 132. Surfaces 130 and 132 are generally flat surfaces and as described previously protrusions 126 extend upwardly from top surface 130. Bottom surface 132 has a generally conically shaped opening 134 therein which creates a generally frusto-conically shaped fastener mount, or mounting post 136 on top surface 130. A top panel 138 of mounting post 136 has an opening 140 therethrough for receiving a fastener 142. As shown in FIG. 10, top panel 138 has a generally flat surface 139 extending radially inwardly at the upper end of mounting post 136. Top panel 138 extends downwardly therefrom to create a cavity 141 in which a stem 146 of fastener 142 will extend. Stem 146 is connected to a head or handle portion 144 of fastener 142. Threaded stem 146 will thread into insert 114 and handle portion 144 will press against floor panel 128 and more specifically against mounting post 136 to removably affix wheeled dolly 15 to pan carrier body 10. Thus, a single removable fastening member will attach wheeled dolly 15 to pan carrier body 10. The advantages to such an arrangement are evident. For example, converting wheeled food pan carrier 5 to a stackable pan carrier body 10 is more efficiently accomplished than with prior art wheeled carriers. The removal of one fastener accomplishes such a conversion, and will remove dolly 15 exposing flat surfaces on bottom 32 of food pan carrier body 10. In the prior art, a separate dolly strapped to a pan carrier was used to make pan carriers mobile, or four wheels were attached directly to a pan carrier body. Wheeled dolly 15 when attached to pan carrier body 10 also gives the appearance of a pan carrier body with wheels attached thereto.

Wheeled dolly 15 has an outer ring or side wall 150 which extends along first or left side 152 and second or right side 154 of dolly body 120. A slight radius 156 exists along the upper edge of outer ring 150 and transitions downwardly into a generally flat, or planar surface 158. Outer ring 150 extends into corners 160 of dolly body 120 and transitions into forward and rear shoulders 162 and 164, both of which extend upwardly from floor panel 128. Surface 158 is generally coplanar with surface 82 on pan carrier body 10. Thus, skirt 80 transitions smoothly into side wall or outer ring 150 of dolly body 120. Forward and rear shoulders 162 and 164 both have a height 166 and a width 168. Width 168 is generally the same as depth 107 of receptacles 102. Height 166 and width 168 are such that forward and rear shoulders 162 and 164 will be received and nest in the receptacles 102 and 104 defined in pan carrier body 10. Shoulders 162 and 164 thus have an outer peripheral shape, or surface like the outer peripheral surfaces 63 and 65 of handles 62 and 64.

Pan carrier 5 as described herein may be utilized to carry a plurality of pans containing food as is known in the art. Pan carrier 5 may be converted from a wheeled pan carrier 5 to a stackable carrier simply by removing a single fastener which allows removal of wheeled dolly 15. Converting back to a wheeled pan carrier 5 simply requires insertion and hand rotation of a thumb screw 142 or similar fastener which will attach a wheeled dolly 15 to the pan carrier body 10.

Thus it is seen that the present invention is well adapted to carry out the objects and attain the ends and advantages mentioned above as well as those inherent therein. While certain preferred embodiments of the invention have been described for the purpose of this disclosure, numerous changes in the construction and arrangement of parts and the performance of steps can be made by those skilled in the art, which changes are encompassed within the scope and spirit of this invention as defined by the appended claims.

What is claimed is:

1. A food pan carrier comprising:
a pan carrier body for receiving food pans, the pan carrier body having caster surfaces for engaging caster plates to allow wheels to be attached directly thereto; and
a wheeled dolly removably connected to the pan carrier body with at least one fastener, wherein the wheeled dolly covers the caster surfaces when connected to the pan carrier body.

2. The food pan carrier of claim 1, the wheeled dolly comprising a dolly body and four wheels connected to the dolly body, wherein the at least one fastener extends through the dolly body into the pan carrier body.

3. (canceled)

4. The food pan carrier of claim 1, wherein the pan carrier body has forward and rear handles extending upwardly from a top thereof, and forward and rear receptacles at a bottom thereof, wherein the forward and rear receptacles are shaped to receive the handles of a pan carrier body stacked therebelow.

5. The food pan carrier of claim 4, the dolly body comprising forward and rear shoulders extending upwardly from a floor panel thereof, wherein the forward and rear shoulders are received in the forward and rear receptacles when the wheeled dolly is connected to the pan carrier body.

6. A food pan carrier comprising:
a pan carrier body; and
a wheeled dolly removably connected to the pan carrier body with a single fastener extending through the wheeled dolly and into the pan carrier body, the wheeled dolly defining forward and rear shoulders extending upwardly from a floor panel, wherein the pan carrier body has forward and rear cutaway portions adapted to receive the forward and rear shoulders.

7. The food pan carrier of claim 6, the pan carrier body comprising a plurality of side walls defining an opening for receiving food pans.

8. The food pan carrier of claim 7, the pan carrier body comprising a plurality of flat surfaces on a bottom thereof for engaging caster plates to allow direct connection of wheels to the pan carrier body when the wheeled dolly is disconnected therefrom.

9. (canceled)

10. The food pan carrier of claim 9, the pan carrier body comprising forward and rear handles, wherein the periphery of the forward and rear handles is shaped substantially the same as the periphery of the forward and rear shoulders on the dolly body.

11. The food pan carrier of claim 6, wherein the pan carrier body transitions smoothly into the dolly body at the sides thereof.

12. A food pan carrier comprising:
a pan carrier body, the pan carrier body defining an opening for receiving food pans;
a dolly body removably connected to the pan carrier body with at least one fastener, wherein the pan carrier body transitions smoothly into the dolly body at the sides thereof, and wherein a bottom of the pan carrier body is adapted to engage and be stacked directly upon a top of a second pan carrier body; and
a plurality of wheels connected to the dolly body.

13. The food pan carrier of claim 12, the dolly body removably connected to the pan carrier body with a single fastener.

14. The food pan carrier of claim 12, the pan carrier body defining an internal thread in a bottom thereof for receiving the at least one fastener, and having flat surfaces to allow caster plates to be attached directly thereto when the dolly body is disconnected from the pan carrier body.

15. (canceled)

16. The food pan carrier of claim 15, wherein the pan carrier body comprises forward and rear handles at the top thereof, and defines forward and rear cavities at the bottom thereof for receiving the forward and rear handles of a pan carrier body stacked thereunder.

17. The food pan carrier of claim 16, wherein the dolly body has forward and rear shoulders extending upwardly from a floor panel thereof, and wherein the forward and rear shoulders are received in the forward and rear cavities of the pan carrier body when the dolly body is connected thereto.

18. The food pan carrier of claim 17, wherein an outer peripheral shape of the forward and rear shoulders is substantially the same as the outer peripheral shape of the forward and rear handles.
